(19) United States
(12) Patent Application Publication
(10) Pub. No.: US 2016/0296069 A1
(43) Pub. Date: Oct. 13, 2016

(54) GRILLING APPLIANCE

(71) Applicant: METALLWARENFABRIK MARKTOBERDORF GMBH & CO. KG, Marktoberdorf (DE)

(72) Inventor: Carsten Hemmers, Nordhorn (DE)

(73) Assignee: METALLWARENFABRIK MARKTOBERDORF GMBH & CO. KG, Marktoberdorf (DE)

(21) Appl. No.: 14/916,306

(22) PCT Filed: Sep. 3, 2014
(86) PCT No.: PCT/EP2014/002385

§ 371 Date: May 31, 2016

(30) Foreign Application Priority Data
Sep. 3, 2013 (DE) 10 2013 014 540.6

(51) Int. Cl. A47J 37/07

(52) U.S. Cl. CPC A47J 37/0754; A47J 37/0763; A47J 2037/0777

(57) ABSTRACT

According to the invention, a barbeque appliance (2) comprises a charcoal chamber (12), the walls of which completely enclose an interior space for charcoal, comprising at least one wall (48) made of a fine-meshed screen and comprising at least one ventilation opening (44) into which an air-supply pipe (26, 32, 14) opens, which leads through an ignition chamber (14) for ignition means (36) and to which an air-flow generator (4) is or can be connected, and comprising a reflector shell (21), in which the charcoal chamber (12) is arranged and which is made of flexible planar material having a heat-reflecting inner face, and comprising an outer shell (8) in which the reflector shell (21) is arranged, preferably so as to be at a spacing from the outer shell (8) at least in regions by way of an air space (26), and comprising a barbeque rack (6), which covers the outer shell (8) at the top.

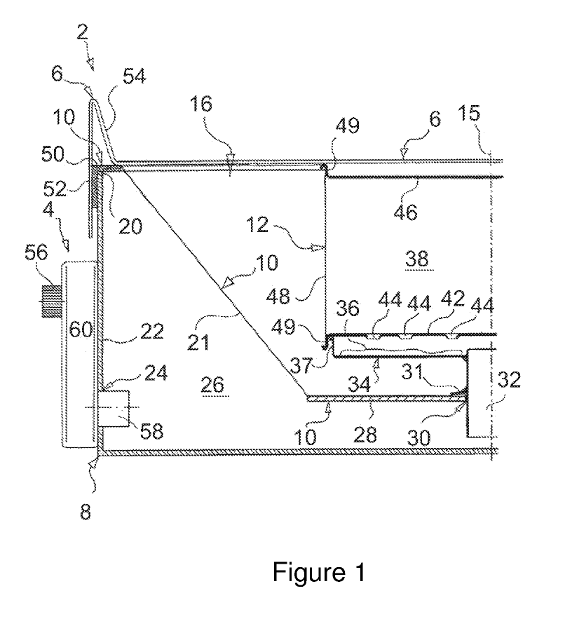

The present invention relates to a barbeque appliance comprising a charcoal chamber, the walls of which completely enclose an interior space for charcoal, comprising at least one wall made of a fine-meshed screen and comprising at least one ventilation opening into which an air-supply pipe opens, which leads through a kindling chamber for ignition means and to which an air-flow generator is or can be connected, and comprising a reflector shell and comprising an outer shell in which the reflector shell is arranged (preferably so as to be at a spacing from the outer shell at least in regions by way of an air space), and comprising a barbeque rack, which covers the outer shell at the top.

People have long used fire and embers as a heat source, in particular also for cooking. Modern technology has developed a wide range of appliances and method for these purposes. In addition, people's fascination with embers and fire will never cease. We find the heat from a wood fire cosy, and on warm days barbequing is a very popular leisure activity.

The utility model DE 202004017817 U1 describes a heat source comprising a charcoal chamber, comprising a wall made of a fine-meshed screen and comprising at least one ventilation opening into which an air-supply pipe opens, to which an air-flow generator, in particular a fan, is or can be connected, and comprising a reflector shell, in which the charcoal chamber is arranged, and an outer shell, in which the reflector shell and the charcoal chamber are arranged.

This appliance is disadvantageous on account of the very complex production, the large amount of space the appliance requires, for example for storage, and the effort required for cleaning the many parts.

The problem addressed by the present invention is to provide a barbeque appliance of the type mentioned at the outset that is improved in terms of handling.

This problem is solved by an appliance having the features of claim 1. Preferred embodiments are found in the dependent claims.

According to the invention, an appliance for the targeted generation of heat is characterised in that charcoal or another coal-like fuel, which can for example be produced by pyrolysis or calcination (always just referred to as “charcoal” in the following by way of example), can be held in a substantially closed charcoal chamber or embers chamber when it is hot. The hot charcoal can be safely enclosed by the substantially closed embers chamber so that the embers chamber can even tip over without embers that fall out causing danger to the surroundings. In addition, however, the substantially closed embers chamber also means that the majority of the heat radiated from the embers is directed through a fine-meshed, screen-like wall (mesh in particular<1 mm) of the embers chamber, the fine-meshed, screen-like wall of the embers chamber being arranged below a barbeque rack of a barbeque appliance. Even if the embers chamber is made of sheet metal (for example stainless steel or tinplate), for example, and therefore heats up itself and transports heat, the fine-meshed screen will allow a greater amount of heat to penetrate. Since the diameter of the pieces of charcoal in the embers chamber is preferably essentially below 25 mm, the charcoal can be very easily and rapidly set on fire (with a low amount of energy). An embers chamber that is very easy to handle can also be formed for this size of charcoal. The embers chamber is preferably filled with approximately 150 g of charcoal. This may be sufficient for a burn duration of approximately 30 to 60 minutes, due to a preferably controllable air flow which can be introduced into the embers chamber through a ventilation opening by a fan by means of an air-supply pipe.

Other sizes of the embers chamber are conceivable according to the invention. The volume and the design of the embers chamber can therefore be accordingly implemented or adapted such that they vary depending on changing requirements and/or purposes and on the desired burn time. The embers chamber in the system may therefore also be larger or smaller.

Charcoal which has the following constituents is particularly preferred for the method according to the invention: 40% to 60% charcoal having a diameter of each piece of from 5 mm to 20 mm, 40% to 60% charcoal having a diameter of each piece of from 20 mm to 25 mm, and a remainder of smaller fragments and dust, which are produced during transport, for example. In this way, the half of the charcoal having the smaller pieces makes ignition easier, while the other half of the charcoal having the larger pieces improves the burn duration.

The burning in the charcoal chamber or embers chamber can be intensified by the air flow being fed into the embers chamber. If, therefore, the embers are blown on according to the invention, in particular by means of an electric fan—or, for example, by means of a hand-crank-operated fan in order to be independent of electrical power—the embers become hotter, and the radiated energy increases. Once the air flow is stopped again, the embers die down and they cool down without, however, completely going out, and therefore can once again be set on fire to produce greater amounts of heat by air being fed in again. It is particularly preferable to adjust the intensity of the air flow, whether this be by setting a higher fan speed or by cranking more quickly, for example, continuous adjustability of the electrical fan power being particularly preferable.

It is also particularly preferable for the coals in the embers chamber to be set on fire by an ignition means which is ignited in the vicinity of the charcoal, and the overall heat from which is conducted into the embers chamber to the charcoal by means of an air flow—in particular the air flow from the fan by means of which the burning can also be intensified. The ignition means may for example be in the form of matchstick heads, but in a larger quantity. The ignition means is preferably ignited close to the charcoal in an ignition chamber adjacent to the embers chamber, and the heat from the ignition means is supplied to the charcoal. Combustion gel or combustion paste is particularly preferable. However, other known flammable (solid, pyrotechnic or liquid) substances and mixtures are also conceivable as the ignition means. Therefore, paraffin (also grated paraffin) is considered suitable, for example. It is in particular advantageous according to the invention for a small quantity of ignition means to be sufficient owing to the low amount of energy required to set the charcoal on fire.

The barbeque appliance preferably comprises a cylindrical charcoal chamber comprising a substantially planar top cover made of possibly perforated sheet metal, a fine-meshed screen as a “cylindrical outer surface”, a substantially planar base at the bottom made of sheet metal and at least one ventilation opening in the base.

An air-supply pipe opens into the ventilation opening in the charcoal chamber from outside the charcoal chamber, to which pipe the air-flow generator is or can be connected. To do this, a blow drier could even be placed onto the air-supply pipe from the outside, for example. However, a fan may also be integrated or installed directly into the appliance and can thus supply the air-supply pipe with an air flow.

The barbeque appliance also comprises an ignition chamber for an ignition means, as already described above. The ignition chamber is preferably arranged close to the charcoal chamber (or is even integrated therein) and preferably opens into a lower region of the charcoal chamber through at least one ignition opening. A plurality of ignition openings through which the air heated by the lit ignition means is conveyed to the charcoal are preferred, however, in order to set fire to said charcoal.

Particularly preferably, the air-supply pipe extends through the ignition chamber. The ventilation openings in particular (or optionally one of the ventilation openings) that lead into the charcoal chamber from the air-supply pipe can then also act as ignition openings. In addition, the air flow that is conveyed through the air-supply pipe from the outside can on one hand be used to convey the heat from the ignition means to the charcoal when setting fire to the coals and on the other hand can later be used to intensify the heat from the embers when the charcoal is alight.

A pan for the ignition means is preferably arranged in the ignition chamber. If the air-supply pipe extends through the ignition chamber, the air flow from the air-supply pipe preferably does not flow directly through this pan, but instead swirls therethrough. This is caused for example by the air flow being introduced into the ignition chamber from below through an opening in the centre of the pan and then leaving again at the top through a plurality of openings distributed peripherally around the centre of the pan—that is to say on a path that changes direction at least twice, for example. This pan is in particular suitable for small lines of combustion paste to be laid therein from a tube of combustion paste. Preferably, the air pipe is enlarged under the charcoal chamber to form a planar chamber in the form of an ignition chamber on which the charcoal chamber rests.

Foods such as meat or fish can be cooked using the barbeque appliance according to the invention. For this purpose, the barbeque appliance according to the invention comprises a substantially horizontal barbeque rack, below which is positioned the cylindrical charcoal chamber preferably comprising a substantially planar top cover made of possibly perforated sheet metal, a fine-meshed screen in the form of a “cylindrical outer surface” and a substantially planar base at the bottom made of sheet metal. Preferably, there is a spacing of from 0 to 5 cm between the charcoal chamber and the barbeque rack—the barbeque rack may thus also rest directly on the top of the charcoal chamber.

According to the invention, the charcoal chamber is contained in a reflector shell and this reflector shell is contained in an outer shell which encloses the reflector shell, preferably so as to be at a spacing therefrom by way of an air space. As a result, the outer shell is not hot on the outside. Even if it is accidentally touched, there is therefore no risk of getting burned. Preferably, the air pipe is formed below the reflector shell (in particular between the reflector shell and the outer shell) by this air space that provides a spacing. The air flow conveyed therethrough additionally cools this region (in particular the reflector shell and the outer shell) and in this way advantageously promotes the effect whereby the reflector shell and the outer shell can be made of heat-sensitive material and whereby the outer shell can be placed on heat-sensitive surfaces because it hardly gets hot, or does not get hot at all, on the bottom.

The outer shell may be made of a material that burns or carbonises even at a temperature of below 200° C., and specifically may in particular be made of plastics material, wood, paper and/or cardboard. Specifically, the air space is dimensioned such that the inner wall of the outer shell does not get hotter than 180° C., in particular than 120° C., in particular than 80° C., at any point. These materials of the outer shell allow for particularly cost-effective production. When it is made of cardboard or paper material, the outer shell can even be printed and therefore is particularly suitable as an advertising medium. Production is particularly cost-effective if the outer shell is designed as a cardboard box (that is cuboid and in particular has a square base) without a lid. Alternatively, a lid may be removable like that of a shoebox or may be foldable to the side along an edge in order for the barbeque rack to be placed thereon during use.

According to the invention, the reflector shell is made of flexible planar material having a heat-reflecting inner face (metal foil layer or metal foil vapour deposition), and is preferably made of a metal foil such as aluminium foil. Here, “flexible” means that the planar material can be visibly (resiliently or plastically) deformed by hand or preferably even using one finger without additional tools, as is the case for aluminium foil, for example. This feature can in turn considerably reduce production costs. In addition, this allows the reflector shell to be sold as a “disposable item” or a “single use item”. Since the preferably funnel-shaped reflector shell can in particular be used to reflect the heat radiated by the charcoal chamber (in a manner and arrangement that are similar to a parabolic mirror) towards the underside of the barbeque rack, the reflector shell is substantially positioned under the entirety of the underside of the barbeque rack. Fat dripping therefrom and anything else falling down therefore in particular almost always lands on the reflector shell, and therefore said shell being designed as a single use item makes their removal after barbequing particularly easy.

This last-mentioned aspect is also significant for an embodiment of the invention in which the reflector shell and the barbeque rack are both designed as single use items, so that the barbeque rack does not have to be cleaned, which is often laborious. In this embodiment, the reflector shell and the barbeque rack may also be fastened to one another as one component or one installation unit, or may even be integrally formed (made of one piece of aluminium foil from which the barbeque-rack region is then cut and deformed in the form of an expanded metal sheet).

Alternatively, the reflector shell may however also be formed according to the invention “in the outer shell”, whereby the outer shell is directly coated with the reflector shell, the reflector shell therefore forming the inside outer layer of the outer shell at least in regions. For this purpose, aluminium in the form of a heat-reflecting material may for example be vapour-deposited on the outer shell, bonded to said shell, or said shell may be coated therewith in another manner.

Particularly preferably, the charcoal chamber is removable. If the reflector shell and the outer shell can be folded flat (the outer shell in the form of a cardboard box for example can be collapsed in one of many conventional ways and the reflector shell made of aluminium foil can be folded flat and/or creased flat), this produces an apparatus which can be transported in a very compact manner, and therefore an apparatus that is yet more cost-effective. Here, the reflector shell may be funnel-shaped, and may in particular have planar walls made of the flexible planar material that together are pyramid-shaped, and for example can be easily pressed together to be flat (and in this case, as already mentioned, have random but also predetermined folds) and easily pulled apart from one another again.

The barbeque rack is therefore positioned above the charcoal chamber, preferably on the outer shell and/or the reflector shell—forming the lid of said chamber on the upper rim thereof in a manner of speaking. The barbeque rack may then particularly preferably be (detachably) fastened to the outer shell, so that even if it tips over there is little to no risk of getting burned, since the barbeque appliance remains as one unit if the reflector and the embers chamber are likewise (detachably) fastened to the outer shell—and, according to the invention, the hot charcoal in the embers chamber is prevented from falling out since it is safely enclosed anyway.

Overall, in accordance with the invention a heat source or a barbeque appliance is thus produced which is clean, safe and quick to operate, and can be produced particularly cost-effectively.

The charcoal chamber comprising the screen and the quantity of charcoal, optionally including air inlets on the underside and/or the ignition chamber comprising ignition means (also the charcoal chamber and ignition chamber together), may be designed as a prefabricated interchangeable unit, and specifically in particular as a prefabricated single use item.

Further advantages, embodiments and details of the invention are described in the following with reference to the accompanying drawings, in which:

The FIGURE shows a sectional side view of a barbeque appliance according to the invention.

The barbeque 2 according to the FIGURE consists substantially only of the following separate components and also of the following materials: a separate battery-operated fan 4 that can be attached and materials as follows: expanded metal (barbeque rack 6), cardboard (outer shell 8, and rim 50 and base 28 of the reflector shell 10), aluminium foil (reflector shell 10) and fine-meshed screen 48 (side wall 48 of the charcoal chamber 12) and thin sheet metal (for example the ignition chamber 14 and the top 46 and the base 42 of the charcoal chamber 12). On account of manufacturing simplicity and costs and of simple assembly, the selected dimensions are symmetrical (along the axis of symmetry 15; only the left-hand half of the symmetrical appliance 2 is shown): the outer shell 8 is in the form of a cardboard box having a square base and the (upside-down) pyramid-shaped reflector shell 10 made of flexible aluminium foil has substantially the same square shape, in the form of an upper opening 16, as the outer shell 8. The barbeque rack 6 is positioned above the charcoal chamber 12 on the outer shell 8 and the reflector shell 10—forming the lid of said chamber on the upper rim 20, 50 thereof in a manner of speaking.

The reflector shell 10 and the outer shell 8 can be folded flat. The outer shell 8 in the form of a cardboard box can be collapsed in one of many ways that are known (from cardboard packaging technology), and this makes it significantly easier to transport and store the product. In addition, the reflector shell 10 can be easily pressed together to be flat in its pyramid-shaped region 21 made of aluminium foil (having random folds in this case) and can then be pulled apart again. Using such a reflector shell 10 that can be pressed flat, after the outer shell 8 is first unfolded, all the elements of the barbeque 2 can also be accommodated and transported in the outer shell.

At this point, the functional design of the barbeque 2 during operation using coal will be explained.

A first through-opening 24 is made in a wall 22 of the outer shell 8. A combustion-air-flow generator 4 (for generating a combustion air flow through the air-supply pipe 26) is inserted into the through-opening 24 from the outside. The through-opening 24 opens into an air-supply pipe 26, which is formed on the base of the appliance 2 in its initial progression by the entire volume 26 between the outer shell 8 and the reflector shell 10. For the further progression of the air-supply pipe 26, a second through-opening 30 is arranged in the centre of the base 28 of the reflector shell 10. A vertical air-supply tube 32 made of sheet metal is inserted therein (and for example prevented from slipping through or tilting by a sheet-metal collar 31 or a bayonet fitting (not shown)) and opens on the bottom into the centre of a sheet-metal pan 34 for ignition means 36 in the form of an ignition chamber 34.

The sheet-metal pan 34 receives a quantity of kindling aid 36—small lines of combustion paste 36 from a tube of combustion paste (not shown). However, this sheet-metal pan 34 also receives the charcoal chamber 12 on its substantially vertical rim 37, and therefore the base of the charcoal chamber 12 simultaneously forms the top of the ignition chamber 34. The charcoal chamber 12 encloses a combustion space 38, in which there is a pile of charcoal (not shown). In order to introduce the air flow into the charcoal chamber 12 through the ignition chamber 14 in a swirling manner as described above, the charcoal chamber 12 has a plurality of ventilation openings 44 in its base 42 made of sheet metal, which are distributed peripherally around the centre of the ignition pan 34.

The charcoal chamber 12 is cylindrical and has a planar top cover 46 made of sheet metal, a fine-meshed screen 48 as a “cylindrical outer surface”, through which the heat from the hot coals (not shown) therein is radiated to the side (in order to be reflected from the pyramid-shaped region 21 made of aluminium foil of the reflector shell 10 towards the barbeque rack), and the planar base 42 at the bottom made of sheet metal and comprising the ventilation opening 44. The cover 46 and the base 42 are placed on the cylindrical outer surface 48 consisting of a fine-meshed screen 48 in the manner of circular lids for tin cans (specifically having a vertical insertion rim 49).

In this way, the combustion space 38 is mechanically tightly and reliably closed. Even if the barbeque appliance 2 tilts or even tips over or falls over, it is almost impossible for either the charcoal (not shown) or the dangerous embers that are possibly contained therein to fall out of the combustion space 38 because the charcoal chamber 12 is clamped, together with the ignition chamber 34, between the barbeque rack 6 at the top and the base 28 of the reflector shell at the bottom. In addition, during operation of the appliance 2, it is ensured that radiant heat passes through the screen wall 48 towards the reflecting region 21 of the reflector shell 10. According to the invention, this design of the flame screen 48 also prevents flying sparks, which can be very dangerous.

The insertion rim 50 of the reflector shell 10 is placed onto the rim 20 of the outer shell 8, specifically in the manner of placing a lid onto a shoebox. Likewise, the barbeque rack 6 made of expanded metal is placed onto the insertion rim 50 of the reflector shell 10 by its insertion rim 52. Both connections can be additionally secured by preferably simple closures (not shown), for example by embossed snap-in raised portions (not shown), which snap into complementary indentations or openings (not shown), or by clips (not shown) which are made of sheet metal or wire, for example.

The reflecting region 21 of the reflector shell 10 lastly extends in the form of an upside-down pyramid made of (four identical faces of) flexible aluminium foil 21 (having substantially the same square shape, in the form of an upper opening 16, as the outer shell 8) in the vertical direction from its planar base 28 (made of cardboard, through which the vertical air-supply tube 32 is inserted) as far as the upper rim 50 of the outer shell 8.

According to the invention, the dimensions of the outer shell 8 and of the reflector shell 10 are coordinated with one another such that the air space 26 is produced between these two shells. In this way, hardly any heat is transferred from the reflector shell 10 to the outer shell 8, and the reflector properties of the reflector shell 21 are fully utilised between the screen wall 48 of the embers chamber 16 and the barbeque rack 6. As a result, as already mentioned, the base of the outer shell 8 is also prevented from heating up by the air space 26 and the air flow therein, in particular also in the immediate surroundings of the embers chamber 12. Therefore, this appliance 2 may even meet the requirements for indoor use, for use directly on a dining table, and even on a wooden tabletop. The safe distance from the barbeque rack 6 then only needs to be adjusted in accordance with people's own sensitivity to heat.

In order for persons to cook food (not shown) that is placed on the barbeque rack 6, the appliance 2 can be touched on all outer faces of the outer shell 8 without there being any risk to the user, while only the barbeque rack 6 on the top of the barbeque appliance 2 is hot and should not be touched. A “rail” 54 around the barbeque rack 6 can then additionally prevent sausages (not shown) from rolling off.

The separate combustion-air-flow generator 4 that can be attached is used for operating the appliance 2 shown. Only a small amount of combustion air in combustion-air flows at low flow speeds is required to operate the appliance 2. This amount should, however, be easily adjustable. A neat solution for a combustion-air-flow generator is a small fan 4 that is operated by means of batteries (not shown) that can be inserted and comprises a battery compartment, a motor, a shaft, a propeller (none of these are shown; variable transformer 56 and air-outlet connectors 58 integrated in a housing 60 made of plastics material)—the air-outlet connectors 58 of which fan can be inserted into the first through-opening 24 in the outer shell 8 to generate the air flow.

1. A barbeque appliance comprising:
a charcoal chamber, the walls of which completely enclose an interior space for charcoal, comprising at least one wall made of a fine-meshed screen and comprising at least one ventilation opening into which an air-supply pipe opens, which leads through an ignition chamber for ignition means and to which an air-flow generator is or can be connected;
a reflector shell, in which the charcoal chamber is arranged and which is made of flexible planar material having a heat-reflecting inner face;
an outer shell in which the reflector shell is arranged; and
a barbeque rack, which covers the outer shell at the top.

2. The barbeque appliance according to claim 1, wherein the reflector shell can be folded flat or can be creased flat.

3. The barbeque appliance according to claim 1, wherein the reflector shell consists of aluminium foil and can be folded flat or can be creased flat.

4. The barbeque appliance according to claim 1, wherein the reflector shell comprises flat walls that are made of the flexible planar material and together are funnel-shaped.

5. The barbeque appliance according to claim 1, wherein the outer shell can be folded flat.

6. The barbeque appliance according to claim 1, wherein the outer shell is a cardboard box.

7. The barbeque appliance according to claim 1, wherein the air-flow generator is or can be connected to an opening in the outer shell and wherein a space between the outer shell and the reflector shell forms part of the air pipe.

8. The barbeque appliance according to claim 1, wherein the reflector shell comprises a substantially planar base comprising a substantially central through-opening, and wherein a portion of the air-supply pipe is rigid and opens into the ignition chamber on the bottom and can be inserted into the through-opening from the top.

9. The barbeque appliance according to claim 1, wherein the reflector shell has an upper rim that can be placed over the upper rim of the outer shell in the manner of a shoebox lid.

10. The barbeque appliance according to claim 1, wherein the barbeque rack is made of expanded metal and comprises an upwardly folded rail or a downwardly folded collar rim so that it can be placed onto the outer shell or the reflector shell.
